(19) United States
(12) Patent Application Publication
(10) Pub. No.: US 2017/0346312 A1
(43) Pub. Date: Nov. 30, 2017

(54) METHOD FOR MANAGING CHARGING PROCESS TO PORTABLE COMPUTERS

(71) Applicants: Chih-Hsiung Chang, Taipei City (TW); Hsiang-Ling Wang, Taipei City (TW)

(72) Inventors: Chih-Hsiung Chang, Taipei City (TW); Hsiang-Ling Wang, Taipei City (TW)

(73) Assignee: I/O INTERCONNECT, LTD., Santa Ana, CA (US)

(21) Appl. No.: 15/213,396

(22) Filed: Jul. 19, 2016

Related U.S. Application Data
(60) Provisional application No. 62/342,224, filed on May 27, 2016.

(51) Int. Cl. H02J 7/00; G06F 1/26

(52) U.S. Cl. CPC H02J 7/0027; H02J 7/007; G06F 1/263; G06F 1/266

(57) ABSTRACT

The method includes: a) connecting a dock between a laptop and a power adapter; b) checking whether a smartphone is connected to the dock; c) verifying whether AC power can supply power over a required value of the laptop if yes in step b); d) verifying whether a residual battery capacity of the laptop is greater than 80% if yes in step c); e) verifying whether another smartphone is connected to the dock if yes in step d); f) verifying whether to enable data transfer if yes in step e); g) activating a CDP mode if yes in step f); h) activating a DCP mode if no in step f); i) verifying whether to enable faster charging if no in step e); j) going back to step f) if yes in step i); k) activating an SDP mode if no in step i); and l) showing a warning if no in steps b), c) or d).

### RELATED APPLICATIONS

This application claims priority to provisional applications U.S. 62/342,224, filed May 27, 2016.

### BACKGROUND OF THE INVENTION

### 1. Technical Field

The invention relates to battery charging to portable computers such as laptop computers, tablet computers and smartphones.

### 2. Related Art

Traditionally, a laptop computer must be charged directly by a power adapter. The power adapter may not be able to normally charge the laptop computer when the power adapter malfunctions or does not match the laptop computer in specification. In other words, the charging time may become much longer. Such a situation cannot be known by the user. This may cause inconvenience or trouble for users. However, there is no solution in the market.

### SUMMARY OF THE INVENTION

An object of the invention is to provide a method for managing a charging process to portable computers, which can detect whether the power adapter which is charging a laptop computer is in normal condition and show a warning to the user if the power adapter is abnormal.

To accomplish the above object, the method for managing a charging process to portable computers of the invention includes the following steps of: a) electrically connecting a dock between a laptop computer and a power adapter to form a charging power flow from the power adapter to the laptop computer through the dock; b) checking whether a smartphone is connected to the dock or not; c) verifying whether AC power can supply power over a required value of the laptop computer if yes in step b); d) verifying whether a residual battery capacity of the laptop computer is greater than a threshold percentage if yes in step c); e) verifying whether another smartphone is connected to the dock if yes in step d); f) verifying whether to enable data transfer if yes in step e); g) activating a CDP (Charging Downstream Port) mode if yes in step f); h) activating a DCP (Dedicated Charging Port) mode if no in step f); i) verifying whether to enable faster charging if no in step e); j) going back to step f) if yes in step i); k) activating an SDP (Standard Downstream Port) mode if no in step i); and l) showing a warning to the user if no in steps b), c) or d).

### BRIEF DESCRIPTION OF THE DRAWINGS

FIG. 1 is a block diagram of the hardware arrangement of the first embodiment of the invention;

FIG. 2 is a flowchart of the method of the first embodiment of the invention;

FIG. 3 is a block diagram of the hardware arrangement of the second embodiment of the invention;

FIG. 4 is a flowchart of the method of the second embodiment of the invention.

### DETAILED DESCRIPTION OF THE INVENTION

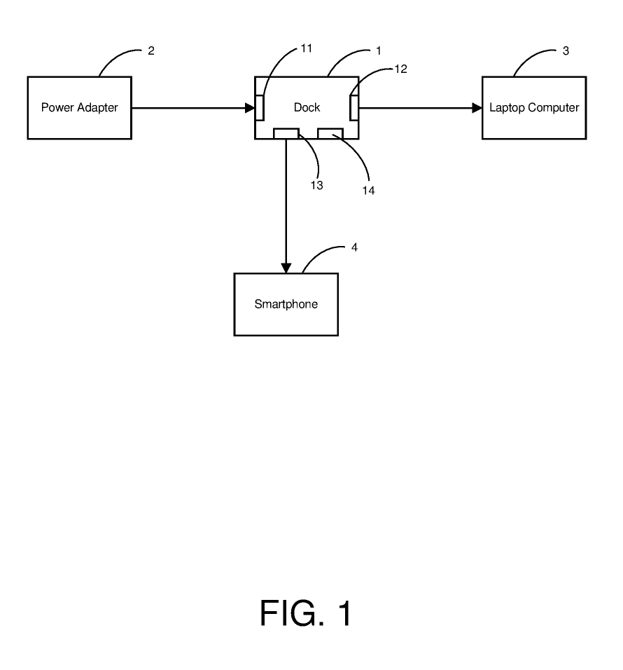

Please refer to FIG. 1. In the aspect of hardware, the first embodiment of the invention provides a dock 1 connected between a power adapter 2 and a laptop computer 3. The dock 1 is provided with two USB (universal serial bus) type-C ports 11, 12 and two or more USB type-A ports 13, 14. As a result, a charging power flow is formed from the power adapter 2 to the laptop computer 3 through the dock 1. Additionally, the dock 1 may be an embedded system.

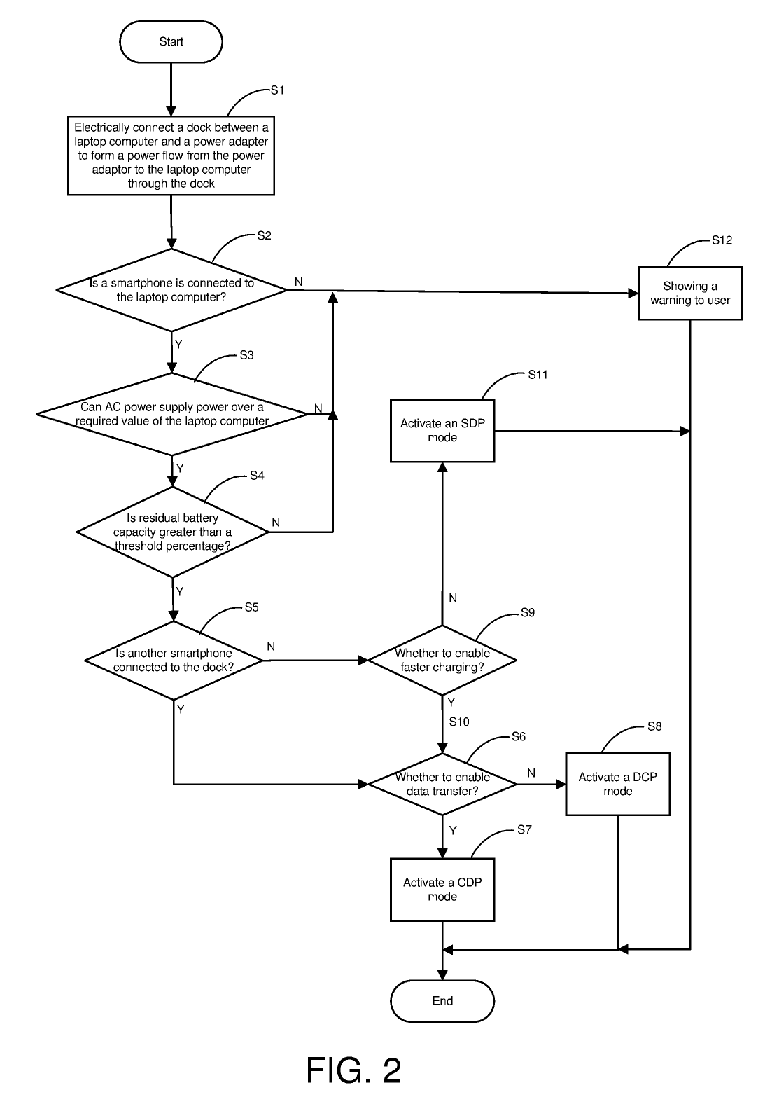

Please refer to FIG. 2, which shows a flowchart of the method of the first embodiment of the invention. In step S1, the dock 1 is electrically connected between the laptop computer 3 and the power adapter 2 to form a charging power flow from the power adapter 2 to the laptop computer 3 through the dock 1. The connections between the power adapter 2 and the dock 1 and between the dock 1 and the laptop computer 3 use USB type-C. The dock 1 is installed with a proprietary software application.

In step S2, the software application checks whether a smartphone is connected to one of the USB type-A ports 13, 14 of the dock 1 or not. In step S3, the software application verifies whether AC power to the power adapter 2 can sufficiently supply power as or over a required value of the laptop computer 3 or not if yes in step S2. This step may be implemented by acquiring a specification from the power adapter 2 or measuring output voltage and current of the power adapter 2. In step S4, the software application verifies whether a residual battery capacity of the laptop computer 3, which has been verified in step S3, is greater than a threshold percentage if yes in step S3. Preferably, the threshold percentage may be 80%. In step S5, the software application verifies whether an additional smartphone 4 is connected to the dock 1 if yes in step S4.

In step S6, the software application verifies whether to enable data transfer if yes in step S5. This step may be implemented by asking a user to determine. In step S7, the software application activates a CDP (Charging Downstream Port) mode if the user chooses yes in step S6. In the USB specification, the Battery Charging Specification, Rev 1.1, Apr. 15, 2009 (BC1.1), acknowledges charging and describes power sources that can supply up to 1.5 A. The “Battery Charging Specification” document contains how power should be drawn from a USB port for charging. Actual charging methods are still left up to the individual designs. BC1.1 goes beyond the power distribution described in USB 2.0 by defining additional power sources for charging. It defines three different source types:

1. Standard Downstream Port (SDP)

This is the same port defined by the USB 2.0 spec and is the typical form found in desktop and laptop computers. The maximum load current is 2.5 mA when suspended, 100 mA when connected and not suspended, and 500 mA (max) when configured for that current. A device can recognize a SDP with hardware by detecting that the USB data lines, D+ and D−, are separately grounded through 15 kΩ, but it still needs to enumerate to be USB compliant. In USB 2.0, it is not strictly legal to draw power without enumerating, although much of present-day hardware does just that, and in violation of the spec.

2. Charging Downstream Port (CDP)

BC1.1 defines this new, higher current USB port for PCs, laptops, and other hardware. Now the CDP can supply up to 1.5 A, which is a departure from USB 2.0 because this current can be supplied before enumeration. A device plugged into a CDP can recognize it as such by means of a hardware handshake implemented by manipulating and monitoring the D+ and D− lines. (See USB Battery Charging Specification, section 3.2.3.) The hardware test takes place before turning the data lines over to the USB transceiver, thus allowing a CDP to be detected (and charging to begin) before enumeration.

3. Dedicated Charging Port (DCP)

BC1.1 describes power sources like wall warts and auto adapters that do not enumerate so that charging can occur with no digital communication at all. DCPs can supply up to 1.5 A and are identified by a short between D+ to D−. This allows the creation of DCP “wall warts” that feature a USB mini or micro receptacle instead of a permanently attached wire with a barrel or customized connector. Such adapters allow any USB cable (with the correct plugs) to be used for charging.

In step S8, the software application activates a DCP (Dedicated Charging Port) mode if the user chooses no in step S6. In step S9, the software application verifies whether to enable faster charging if no other smartphone is connected to the dock 1 in step S5. This step may be implemented by asking a user to determine or automatic determination of the software application depending upon a threshold of an output current or power of the power adapter 2. In step S10, the software application goes back to step S6 if the user or the software application determines yes in step S9. In step S11, the software application activates an SDP (Standard Downstream Port) mode if the user or the software application determines no in step S9. Finally, in step S12, the software application shows a warning to the user if no in steps S2, S3 or S4 because it is in an unknown status and charging cannot be performed.

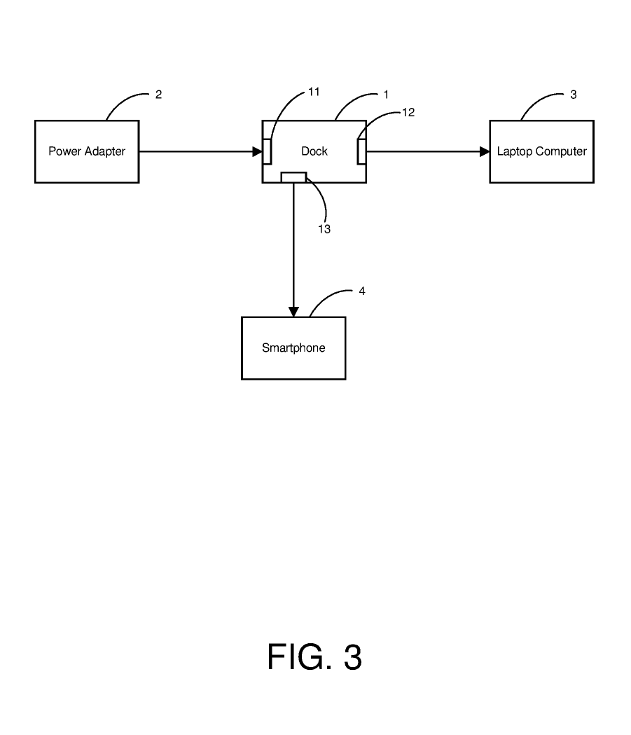

Please refer to FIG. 3. In the aspect of hardware, the second embodiment of the invention provides a dock 1 connected between a power adapter 2 and a laptop computer 3. The dock 1 is provided with two USB (universal serial bus) type-C ports 11, 12 and only one USB type-A port 13. As a result, a charging power flow is formed from the power adapter 2 to the laptop computer 3 through the dock 1.

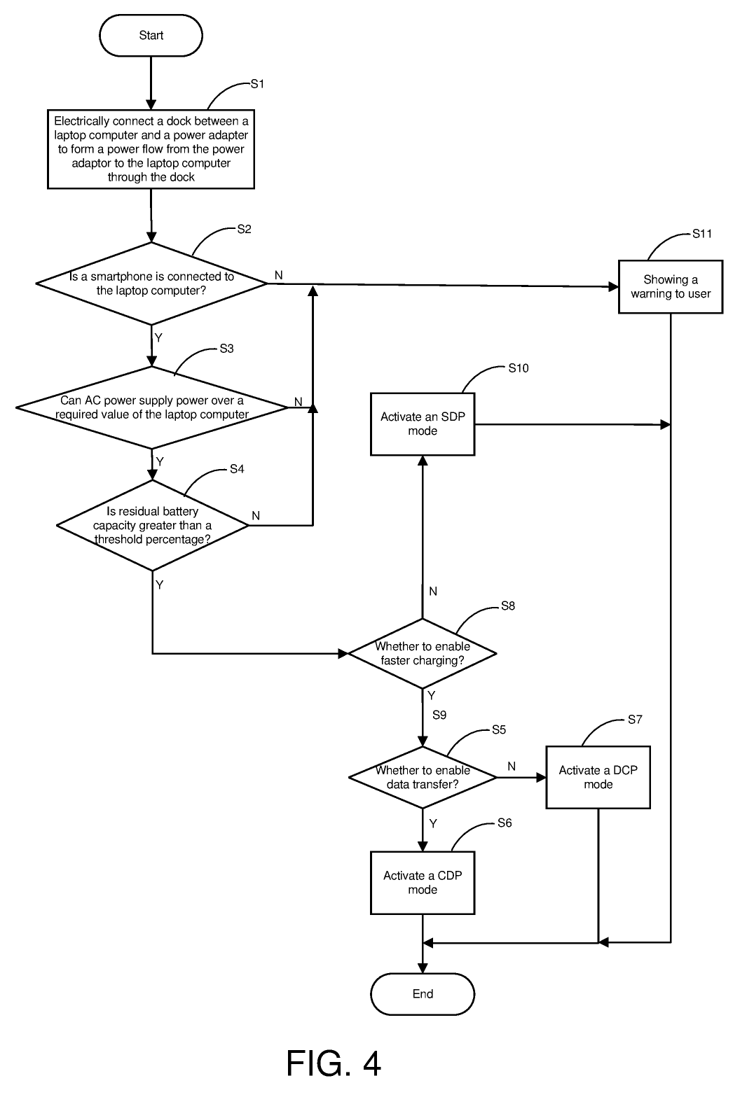

Please refer to FIG. 4, which shows a flowchart of the method of the second embodiment of the invention. In step S1, the dock 1 is electrically connected between the laptop computer 3 and the power adapter 2 to form a charging power flow from the power adapter 2 to the laptop computer 3 through the dock 1. The connections between the power adapter 2 and the dock 1 and between the dock 1 and the laptop computer 3 use USB type-C. The dock 1 is installed with a proprietary software application.

In step S2, the software application checks whether a smartphone is connected to one of the USB type-A ports 13, 14 of the dock 1 or not. In step S3, the software application verifies whether AC power to the power adapter 2 can sufficiently supply power as or over a required value of the laptop computer 3 or not if yes in step S2. This step may be implemented by acquiring a specification from the power adapter 2 or measuring output voltage and current of the power adapter 2. In step S4, the software application verifies whether a residual battery capacity of the laptop computer 3, which has been verified in step S3, is greater than a threshold percentage if yes in step S3. Preferably, the threshold percentage may be 80%.

In step S5, the software application asks a user whether to enable data transfer if yes in step S4. In step S6, the software application activates the CDP mode if the user chooses yes in step S5.

In step S7, the software application activates the DCP mode if the user chooses no in step S5. In step S8, the software application verifies whether to enable faster charging if yes in step S4. This step may be implemented by asking a user to determine or automatic determination of the software application depending upon a threshold of an output current or power of the power adapter 2. In step S9, the software application goes back to step S5 if the user or the software application determines yes in step S8. In step S10, the software application activates the SDP mode if the user or the software application determines no in step S8. Finally, in step S11, the software application shows a warning to the user if no in steps S2, S3 or S4 because it is in an unknown status and charging cannot be performed.

In sum, the invention can automatically manage the charging power flow from a power adapter to a laptop computer. It can guarantee the laptop computer can be normally charged when the power adapter works normally, and show a warning to the user when the power adapter malfunctions or the power adapter does not match the laptop computer.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for managing a charging process to portable computers, comprising:
a) electrically connecting a dock between a laptop computer and a power adapter to form a charging power flow from the power adapter to the laptop computer through the dock;
b) checking whether a smartphone is connected to the dock or not;
c) verifying whether AC power can supply power over a required value of the laptop computer if yes in step b);
d) verifying whether a residual battery capacity of the laptop computer is greater than a threshold percentage if yes in step c);
e) verifying whether another smartphone is connected to the dock if yes in step d);
f) verifying whether to enable data transfer if yes in step e);
g) activating a CDP (Charging Downstream Port) mode if yes in step f);
h) activating a DCP (Dedicated Charging Port) mode if no in step f);
i) verifying whether to enable faster charging if no in step e);
j) going back to step f) if yes in step i);
k) activating an SDP (Standard Downstream Port) mode if no in step i); and
l) showing a warning to the user if no in steps b), c) or d).

2. The method of claim 1, wherein the threshold percentage is 80%.

3. The method of claim 1, wherein the step c) is implemented by acquiring a specification from the power adapter.

4. The method of claim 1, wherein the step c) is implemented by measuring output voltage and current of the power adapter.

5. The method of claim 1, wherein the step i) is implemented by asking a user.

6. The method of claim 1, wherein the step i) is implemented by automatic determination depending upon a threshold of an output current or power of the power adapter.

7. A method for managing a charging process to portable computers, comprising:
a) electrically connecting a dock between a laptop computer and a power adapter to form a charging power flow from the power adapter to the laptop computer through the dock;
b) checking whether a smartphone is connected to the dock or not;
c) verifying whether AC power can supply power over a required value of the laptop computer if yes in step b);
d) verifying whether a residual battery capacity of the laptop computer is greater than a threshold percentage if yes in step c);
e) verifying whether to enable faster charging if yes in step d);
f) verifying whether to enable data transfer if yes in step e);
g) activating a CDP (Charging Downstream Port) mode if yes in step f);
h) activating a DCP (Dedicated Charging Port) mode if no in step f);
i) activating an SDP (Standard Downstream Port) mode if no in step e); and
j) showing a warning to the user if no in steps b), c) or d).

8. The method of claim 7, wherein the threshold percentage is 80%.

9. The method of claim 7, wherein the step c) is implemented by acquiring a specification from the power adapter.

10. The method of claim 7, wherein the step c) is implemented by measuring output voltage and current of the power adapter.

11. The method of claim 7, wherein the step e) is implemented by asking a user.

12. The method of claim 7, wherein the step e) is implemented by automatic determination depending upon a threshold of an output current or power of the power adapter.
